(19) United States
(12) Patent Application Publication
(10) Pub. No.: US 2008/0107146 A1
(43) Pub. Date: May 8, 2008

(54) THERMOMETER CLIP ASSEMBLY HAVING INTEGRATED ACTUATING SURFACE FOR A THERMOMETER CALIBRATION MECHANISM

(75) Inventor: Sharon Hadj-Chikh, Buffalo, NY (US)

Correspondence Address: Stephen B. Salai, Esq.;Harter, Secrest & Emery LLP, 1600 Bausch & Lomb Place, Rochester, NY, 14604-2711, US

(73) Assignee: Robinson Home Products, Inc., Buffalo, NY (US)

(21) Appl. No.: 11/556,561

(22) Filed: Nov. 3, 2006

(51) Int. Cl. G01K 1/14; G01K 15/00

(52) U.S. Cl. 374/1; 374/208

(57) ABSTRACT

A thermometer clip assembly includes probe engaging surfaces for retaining a probe of a thermometer, the thermometer having a calibration mechanism; clamping surfaces for engaging cookware and retaining the clip assembly relative to the cookware; and a calibration mechanism engaging surface for allowing actuation of the calibration mechanism.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention generally relates to cooking utensils, and particularly, to a clip assembly for retaining a probe of a thermometer relative to a piece of cookware, and more particularly, to a clip assembly including a thermometer calibration mechanism actuating surface for operably engaging a calibrating mechanism on the thermometer.

2. Description of Related Art

Thermometers are widely used in cooking processes for food safety concerns, as well as monitoring reactions within the relevant food product to ensure formation of a desired product. However, to provide sufficiently accurate temperature measurements, the thermometer must be retained within the food product, and typically spaced from immediate contact with the cookware.

Accuracy of the thermometer can be important with respect to both food safety as well as product formation. To assist in accuracy of the thermometer, many thermometers include a calibration mechanism, allowing the user to maintain the accuracy of the thermometer. The calibration typically includes adjusting a displayed temperature to correspond to a known sensed temperature, such as boiling water. The calibration of the thermometer requires a separate tool, such as a wrench or screwdriver, which is used to impart the adjustment, or calibration thereby changing the display or the mechanism of the thermometer.

The need exists for a thermometer clip assembly which can operably locate a thermometer relative to the cookware, as well as implement calibration of the thermometer, thereby removing the need for an additional tool or implement to calibrate the thermometer,

### BRIEF SUMMARY OF THE INVENTION

The present thermometer clip assembly provides a clip body for engaging and retaining a probe of a thermometer relative to a piece of cookware. The clip assembly further includes a surface for releasably engaging a calibration mechanism of the thermometer.

In one configuration, the thermometer clip assembly can be used for releasably engaging a thermometer having a longitudinally extending probe and a calibration mechanism, wherein the thermometer clip assembly includes a clip body having a probe engaging portion and a cookware engaging portion, the probe engaging portion contacting the probe, the cookware engaging portion including a pair of biased clamping surfaces and a calibration mechanism actuating surface sized to operably engage the calibration mechanism.

In a further configuration, the probe engaging portion can include a resistive or friction interface with the probe, thereby substantially limiting unintended movement of the probe relative to the thermometer clip assembly.

The disclosure further contemplates a method of calibrating a thermometer, the method including separating a thermometer clip assembly from a probe of a thermometer; and engaging a calibration mechanism actuating surface on the thermometer clip assembly with a calibration mechanism on the thermometer to calibrate the thermometer.

### BRIEF DESCRIPTION OF THE SEVERAL VIEWS OF THE DRAWINGS

FIG. 1 is a side elevational view of the thermometer and the thermometer clip assembly, separate from the cookware.

FIG. 2 is a perspective view of the thermometer clip assembly operably retaining a thermometer relative to a piece of cookware.

FIG. 3 is a perspective view of an underside of a thermometer showing a calibration mechanism, with a portion of the thermometer clip assembly to be operably engaged with the calibration mechanism.

FIG. 4 is a top plan view of the actuation of the calibration mechanism by the thermometer clip assembly.

FIG. 5 is a side elevational view, with a partial cut away, showing the thermometer clip assembly operably engaged with a thermometer.

FIG. 6 is a left elevational view of the thermometer clip assembly, wherein a right side elevation view is a mirror image thereof.

FIG. 7 is a top plan view of the thermometer clip assembly.

FIG. 8 is a bottom plan view of the thermometer clip assembly.

FIG. 9 is a back elevational view of the thermometer clip assembly.

FIG. 10 is a front elevational view of the thermometer clip assembly.

FIG. 11 is a side elevation view of the thermometer clip assembly showing a pair of grommets contacting the thermometer.

### DETAILED DESCRIPTION OF THE INVENTION

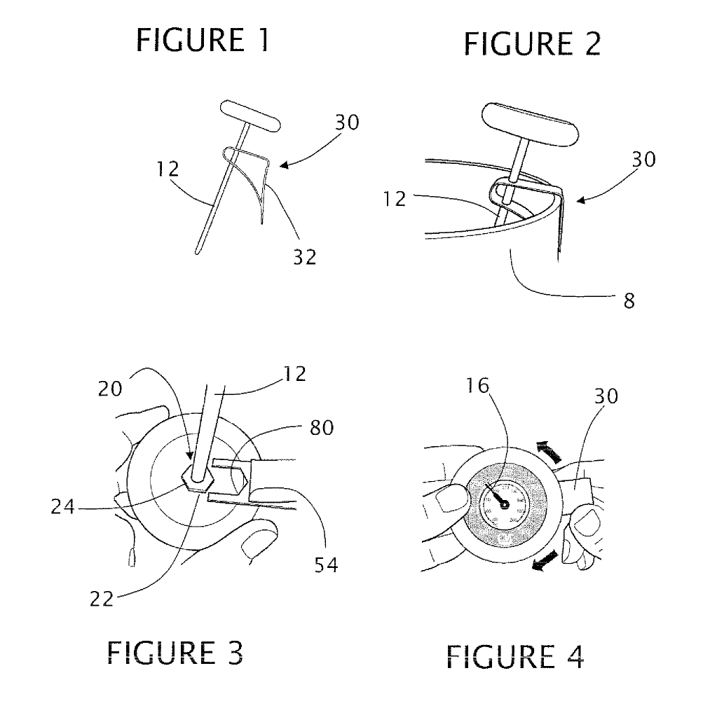

Referring to FIGS. 1, 2, 5 and 11, a thermometer 10 is shown operably engaged with a thermometer clip assembly 30.

Referring to FIGS. 1-5, the thermometer 10 includes a probe 12, typically an elongate member, wherein a portion of the probe is disposed in the material to be measured. The probe 12 makes thermal contact with the material being measured. The thermometer 10 typically includes a dial or face 14 for displaying a measured temperature. The face 14 can include a scale or gradation 18 for assessing the relative position of a needle 16, and hence the temperature. The face 14 can include an arm or the needle 16 which moves relative to the scale to display the sensed temperature. Although the present thermometer 10 is shown with an analog scale, it is understood that the present invention is equally applicable to a digital display.

The thermometer 10 includes a calibration mechanism 20 for adjusting the displayed temperature relative to the temperature of the material being measured. In one configuration, the position of the needle 16 relative to the scale on the face 14, can be manipulated so that the user can maintain the accuracy of the thermometer 10. The calibration mechanism 20 includes an actuating surface 22 operably coupled to the lace 14 such as the needle 16. Manipulation of the actuating surface 22 correspondingly moves the needle 16 relative to the scale 18, or the display relative to the temperature, thereby allowing for calibration. For example, as seen in the FIG. 3, the actuating surface 22 can be configured as a nut 24 which is turned to implement calibration of the thermometer 10. Alternatively, the actuating surface 22 can be a screw, with a slotted surface, a bolt or other threaded device which is selectively moved to implement the calibration of the thermometer 10. Alternatively, it is further understood that slides or cams can be used in the actuating surface 22.

Traditionally, for each of these calibration mechanisms 20, a separate device such as a wrench or a screwdriver is used to effect the calibration.

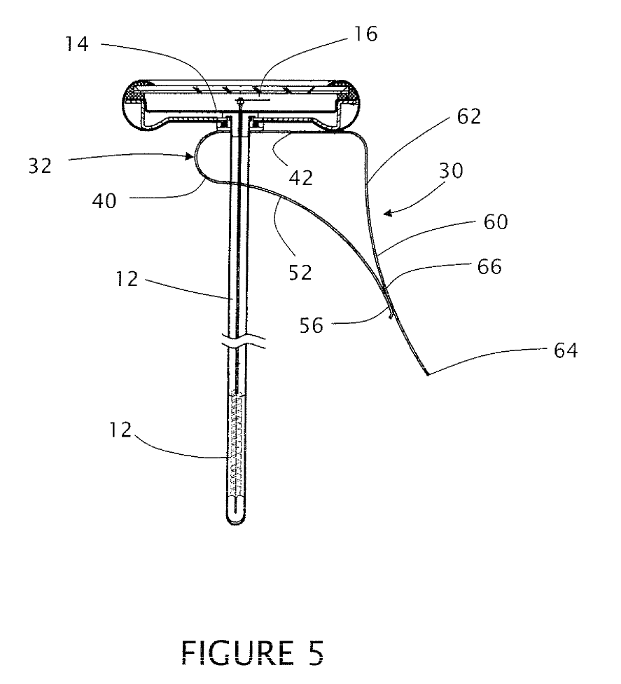

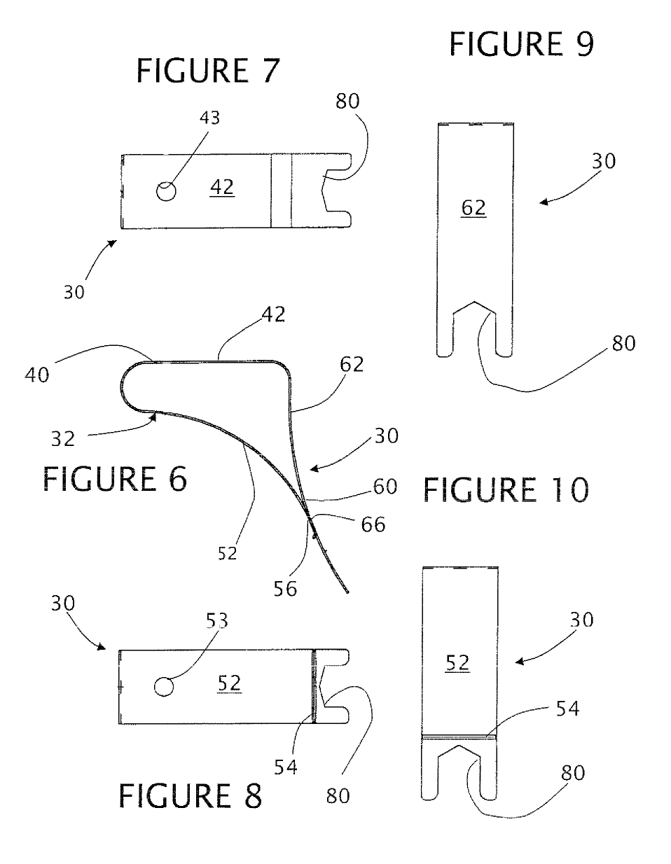

Referring to FIGS. 5 and 6, the thermometer clip assembly 30 includes a clip body 32 and a calibration mechanism actuating surface 80.

Generally, the clip body 32 includes a probe engaging portion 40 and a cookware engaging portion 60. The probe engaging portion 40 contacts the probe 12 and the cookware engaging portion 60 contacts cookware 8 to retain the thermometer clip 30 relative to the cookware.

The probe engaging portion 40 is typically located within a footprint of the cookware 8, and is selected to engage and retain the thermometer 10 relative to the thermometer clip assembly 30. In a further configuration, the probe engaging portion 40 engages the probe 12, to locate the probe relative to the cookware 8.

The cookware engaging portion 60 includes a pair of biased clamping surfaces 56, 66 selected to locate a portion of the cookware 8 there between. Alternatively, the cookware engaging position 60 can include a hook to hang over an outside surface of the cookware 8, while disposing the probe engaging portion 40 within a periphery of the cookware.

The clip body 32 also includes the calibration mechanism actuating surface 80 for engaging the actuating surface 22 of the calibration mechanism 20 on the thermometer 10 to allow for manipulation of the actuating surface and thus calibration of the thermometer.

Referring to FIGS. 1-11, a configuration of the thermometer clip assembly 30 is shown, wherein the thermometer clip assembly includes the clip body 32 having the probe engaging portion 40, the cookware engaging portion 60 and the calibration mechanism actuating surface 80.

In this configuration, the clip body 32 includes an outer leg 62, a spacer leg 42 and an inner leg 52.

The outer leg 62 is selected to contact an outer surface of the cookware 8 and can be substantially linear or curvilinear. The outer leg 62 includes a free end 64. The outer leg 62 includes the clamping surface 66 biased against the corresponding clamping surface 56 of the inner leg 52.

The spacer leg 42 projects from the outer leg 62 at a location spaced from the free end 64. In reference to the operable engagement of the thermometer clip assembly 30 and the cookware 8, the spacer leg 42 extends toward an inside of the cookware. The spacer leg 42 includes a probe receiving recess or aperture 43 sized to engage the probe 12 of the thermometer 10.

Although the spacer leg 42 can project from the outer leg 62 at a variety of angles, it has been found advantageous that the spacer leg project at an angle from approximately 60° to 120° from the outer leg with an advantageous angle of approximately 80° to 100°.

It is understood the spacer leg 42 can connect to the outer leg 62 at a transition, wherein the transition defines a substantially angular connection. Alternatively, the transition can be radiused or curvilinear, as generally shown in FIGS. 5 and 6. In one configuration, the length of the spacer leg 42 is bounded by the connection with the outer leg 62 and connection with the inner leg 52.

The inner leg 52 projects from the spacer leg 42 to terminate at a free end 54. Although the inner leg 52 is shown connected to the spacer leg 42 by a curvilinear transition, it is understood the transition can be angular or curvilinear.

The inner leg 52 includes a probe receiving recess or aperture 53 for engaging the probe 12 of the thermometer 10. In one configuration, the probe receiving recess 53 is an aperture extending through the inner leg 52.

Either probe receiving aperture 43, 53 can define an open or closed periphery. Preferably, the probe receiving recesses 43, 53 sufficiently engage the probe 12 to preclude unintended disengagement of the thermometer clip assembly 30 from the thermometer 10 and preclude movement in a direction transverse to the longitudinal dimension of the probe 12. It is further contemplated, engagement of the probe 12 within the respective recesses 43 and 53 is sufficient to operably retain the thermometer clip assembly 30 relative to the thermometer 10 during operable use, while permitting selective removal of the thermometer from the clip assembly for cleaning and/or storage purposes.

In a further configuration, either or both of the probe receiving aperture 43 or the probe receiving aperture 53 can be configured to have a periphery to form the calibration mechanism engaging surface 80. That is, the periphery of the probe receiving aperture or recess 43, 53 can correspond to the actuating surface 22 of the calibration mechanism 20. Thus, the respective aperture 43, 53 can define the calibration mechanism actuating surface 80.

At least a clamping surface 56 of the inner leg 52 is biased against the clamping surface 66 of the outer leg 62. As seen in the figures, the free end 54 of the inner leg 52 terminates along a length of the outer leg 62 and is generally biased against a portion of the outer leg 62. Thus, the free end 64 of the outer leg 62 projects from the free end 54 of the inner leg 52.

It is understood the clamping surfaces 56, 66 of the inner leg 52 and the outer leg 62 respectively, which are biased against each other, can include a variety of sections of the respective legs. For example, the inner leg 52 can extend beyond the free end 64 of the outer leg 62, such that the clamping surfaces 56, 66 include the free end 64 of the outer leg 62 and a portion of the inner leg 52 spaced from the free end 54. Alternatively, the inner leg 52 and the outer leg 62 can each include a convex portion, wherein the convex portions form the clamping surfaces 56, 66. Such convex portions can be at the free end of the respective inner leg and outer leg 52, 62, or spaced from the free end of the respective inner leg and outer leg, or any combination thereof.

The calibration mechanism actuating surface 80 can be located along any of a variety of portions of the clip body 32. For example, the calibration mechanism actuating surface 80 can be defined by a faceted recess located along a peripheral or lateral edge of the clip body 32. Thus, the calibration mechanism actuating surface 80 can be located along an edge of the inner leg 52, the spacer leg 42 or the outer leg 62.

Although the calibration mechanism actuating surface 80 is shown located at the free end 64 of the outer leg 62, it is contemplated that a plurality of calibration mechanism actuating surfaces 80 can be located along the clip body 32, such as at the free end 54 of the inner leg 52 and the free end 64 of the outer leg 62. Such constructions allow a given thermometer clip assembly 30 to be employed with any of the variety of thermometers 10, wherein the thermometers have differing actuating surfaces for the respective calibration mechanism 20.

As seen in FIGS. 3, 7, 8, and 9, the free end 64 of the outer leg 62 includes the calibration mechanism actuating surface 80 configured as a torque transmitting surface, and specifically a faceted recess for engaging the nut of the calibration mechanism 20. As seen in FIG. 3, the calibration mechanism actuating surface 80 includes a faceted recess sized to engage the nut actuating surface 22 of the calibration mechanism 20.

It is understood the torque transmitting surface of the calibration mechanism actuating surface 80 can be any of a variety of configurations that correspond to the relevant calibration mechanism 20. For example, the torque transmitting configuration of the calibration mechanism actuating surface 80 can be any of hexagonal, octagonal, triangular, rectangular, pentagonal, octagon or other polygonal surfaces. It is further contemplated the calibration mechanism actuating surface 80 can be a blade sized to engage a slotted calibration mechanism 20.

Although the clip body 32 can be formed from any of a variety of materials, including metals, alloys and polymers, a satisfactory material has been found to include spring steel. Further, the clip body 32 can be formed by joining of a plurality of individual legs or sub-sections. The joining can include welding, riveting, clamping or adhesive bonding. However, it has been found satisfactory to form the clip body 32 from a continuous piece of material, such as 0.05 mm 301 stainless steel.

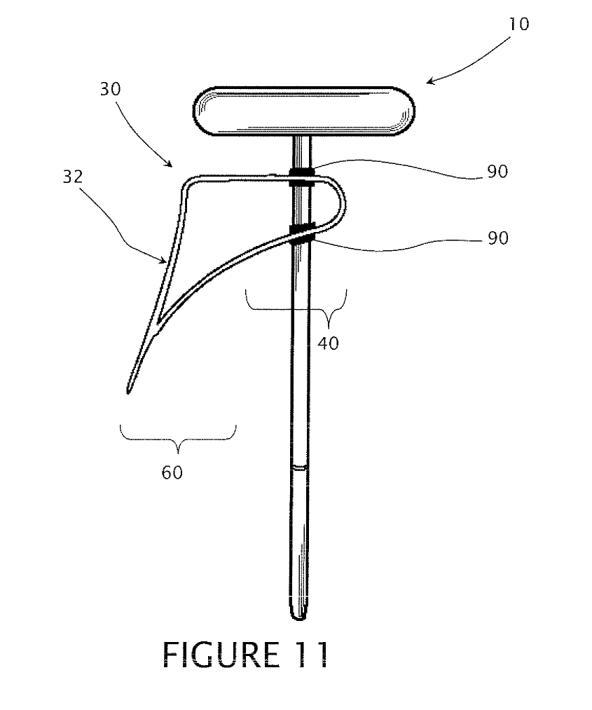

Referring to FIG. 11 the thermometer clip assembly 30 can include a resilient grommet or washer 90 in one or both the probe receiving apertures 43, 53. The grommet 90 is sized to engage the probe 12 in a slightly compressed state, thereby creating a bias against the probe and reducing unintended movement of the probe relative to the thermometer clip assembly 30. The grommet 90 can be formed of a variety of materials that are inert to the cooking environment, such as silicone. In one configuration, the grommets 90 include a peripheral groove into which the thickness of the respective inner leg 52 or spacer leg 42 fits. It is advantageous for the grommets 90 to substantially preclude unintended movement of the thermometer clip assembly 30 relative to the thermometer 10. Thus, unintended contact of the thermometer clip assembly 30 and particularly the spacer leg 42 and the calibration mechanism 80 is generally precluded, thereby minimizing unintended calibration of the thermometer 10.

In use, the thermometer 10 is operably engaged with the thermometer clip assembly 30 by passing the probe 12 through the corresponding recess (aperture) 43, 53 in the spacer leg 42 and the inner leg 52 respectively, as seen in FIGS. 1, 2 and 5. If the grommets 90 are employed, then the probe 12 passes through the grommet as retained within the respective aperture 43, 53.

The inner leg 52 is urged from the outer leg 62 to dispose a portion of the cookware 8 there between, as seen in FIG. 2. The clamping surface 56 of the inner leg 52 is preferably sufficiently biased towards the clamping surface 66 of the outer leg 62 such that upon separation of the free end 54 of the inner leg from the outer leg, to dispose a portion of the cookware 8 there between, the clamping surface 56 of the inner leg biases against an inner surface of the cookware (and the clamping surface 66 contacts an outer surface of the cookware) to operably retain the thermometer clip assembly 30, and hence, attach the thermometer 10 relative to the cookware 8.

The thermometer 10 can slide relative to the thermometer clip assembly 30 to dispose the terminal end of the probe 12 within the relevant material. In the configuration with the grommets 90, the user can overcome the sliding resistance of the grommets and locate the terminal end of the probe 12 within the relevant material. Typically, for calibration purposes, water is boiled, thereby providing the known temperature of 212° F. (100° C.), assuming standard atmospheric pressure.

The thermometer 10 can then be removed from the clip body 32, and the calibration mechanism actuating surface 80, such as the faceted torque transmitting surface is engaged with the calibration mechanism 20 and calibration implemented. Alternatively, the clip body 32 can be removed from the thermometer 10 and the thermometer manually retained relative to the boiling water, with the clip body 32 operably engaged with the calibration mechanism 20 to effect calibration of the thermometer while the probe remains in thermal contact with the food stuff.

While the invention has been described in conjunction with specific embodiments thereof, it is evident that many alternatives, modifications and variation will be apparent to those skilled in the art in light of the foregoing description. Accordingly, the present invention is intended to embrace all such alternatives, modifications and variations as may fall within the spirit and scope of the appended claims.

1. A thermometer clip assembly for releasably engaging a thermometer having a longitudinally extending probe and a calibration mechanism, the thermometer clip assembly comprising:
(a) a clip body having a probe engaging portion, a cookware engaging portion, and a calibration mechanism actuating surface sized to operably engage the calibration mechanism, the probe engaging portion contacting the probe and the cookware engaging portion including a pair of biased clamping surfaces.

2. The thermometer clip assembly of claim 1, wherein the probe engaging portion contacts the probe at longitudinally spaced locations.

3. The thermometer clip assembly of claim 1, wherein the clip body includes an outer leg, a spacer leg and an inner leg, wherein each of the spacer leg and the inner leg include a probe receiving recess.

4. The thermometer clip assembly of claim 3, wherein the probe receiving recess is an aperture.

5. The thermometer clip assembly of claim 3, further comprising a grommet operably retained in the probe receiving recess of at least one of the spacer leg and the inner leg.

6. The thermometer clip assembly of claim 1, wherein the clip body includes a free end, the free end defining the calibration mechanism actuating surface.

7. The thermometer clip assembly of claim 1, wherein the clip body is an integral piece of material including an outer leg, a spacer leg and an inner leg.

8. The thermometer clip assembly of claim 1, further comprising at least one grommet intermediate the clip body and the thermometer.

9. A method of calibrating a thermometer, comprising:
(b) separating a thermometer clip assembly from a probe of a thermometer; and
(c) engaging a calibration mechanism actuating surface on the thermometer clip assembly with a calibration mechanism on the thermometer to calibrate the thermometer.

10. The method of claim 9, further comprising locating a resilient grommet intermediate the thermometer clip assembly and the probe.
